(19) United States
(12) Patent Application Publication
(10) Pub. No.: US 2014/0356074 A1
(43) Pub. Date: Dec. 4, 2014

(54) SEISMIC REINFORCED UNDERGROUND WATER CONDUIT

(71) Applicant: Sanexen Environmental Services, Inc., Brossard (CA)

(72) Inventors: Martin BUREAU, Montreal (CA); Gilles GAGNON, Repentingny (CA); Michael Davison, Brossard (CA); Benoît CÔTÉ, Otterburn Park (CA)

(21) Appl. No.: 13/903,122

(22) Filed: May 28, 2013

(51) Int. Cl. F16L 1/028; D03D 3/02

(52) U.S. Cl. CPC F16L 1/028; D03D 3/02
USPC 405/184.2; 139/387 R

(57) ABSTRACT

A method of reinforcing existing underground water conduits to resist earthquakes and landslides and a reinforcement structural device adapted for insertion into underground water conduits without having to excavate are disclosed. The reinforcement structural device consists of a seamless woven tubular sheath impregnated with a hardening resin which is adapted for insertion into a network of underground water conduits without the need to excavate. The seamless woven tubular sheath consists of continuous longitudinal fiber warp yarn providing tensile strength along the longitudinal axis of the woven tubular sheath and spiralling circumferential fiber filling yarn providing tensile strength around the wall of the woven tubular sheath.

### FIELD OF THE INVENTION

The present invention relates to a method of reinforcing an underground water conduit to resist earthquakes and landslides and to a structural reinforcement device adapted for insertion into an underground water conduit.

### BACKGROUND OF THE INVENTION

Underground water conduits, either potable water pipes, waste water pipes or sewer pipes, are typically made of rigid materials such as reinforced concrete, cast iron, ductile iron, steel and hard polymers such as PVC, HDPE, etc. that are durable and adapted to resist high internal pressure if required and the weight of the landfill covering them. Underground water pipes provide essential services to the urban population, and as a result of their geographical dispersion they remain particularly vulnerable to damage caused by natural disasters. A network of buried water pipes connected together extends over long distances, spreads out in all directions to provide services to residential home or businesses over a wide area and may pass through soils having different properties.

In the event of an earthquake or a landslide, the network of water pipes is subjected to variable ground motions along its various segments and particularly at its various connections for which it may not have been designed to resist. For example, at bends, elbow or tee connections, seismic waves propagating in a certain direction or landslides moving in a certain direction, affect the water pipes before and after bends, elbow or tee connections differently. Previous major earthquakes revealed that most damage of the buried segmented water pipes occurs at the joints and connections of the network of water pipes. It has been proven that the differential motions between the pipe segments are one of the primary reasons that results in damages and ruptures. With the surrounding soil giving way, the external forces exerted on the water pipe network around bends, elbow and tee connections and around straight couplings connecting abutting pipe segments generate high shear and tensile stresses and strains that often exceed the elastic limits of the pipes or the pipes connections leading to multiple ruptures in the network of water pipes at various points thereby partially or completely shutting down water supply to residential home and/or businesses over the area serviced by the water network.

Functioning water systems are a cornerstone of urban human communities, to bring in the clean water on demand for drinking, washing and sanitary needs, and in turn remove the used water from drains, waste, and storm water sources. If the water network system is suddenly rendered partially or totally non-functional by an earthquake or a landslide, critical disruption of the community and public health danger may result. In catastrophic events such as earthquakes, water supply to the population in the aftermath of the event is crucial and must be restored rapidly. However, locating and replacing ruptured or broken pipe segments and pipe connections through a vast network is time consuming and requires heavy machinery for excavation, removal of damage pipes and connections and installation of new pipes and connections.

Newer networks of underground water conduits built in high risk areas are designed to withstand higher shear and tensile stresses and strains such as those generated by earthquakes and landslides. However, the vast majority of underground water networks were built many decades ago based on lower standards and cannot withstand the high shear and tensile stresses and strains generated by earthquakes and landslides.

Replacing older networks of underground water conduits with new ones more adapted to withstand the high shear and tensile stresses and strains generated by earthquakes and landslides is unrealistic because of the sheer magnitude of the work that would be involved. However, reinforcing existing water networks without the need to excavate represents a feasible alternative especially in higher risk areas.

Therefore, there is a need for a method of reinforcing underground water conduits to resist earthquakes and landslides and to a reinforcement structural device adapted for insertion into underground water conduits without having to excavate.

### SUMMARY OF THE INVENTION

It is an object of the present invention to ameliorate at least some of the inconveniences present in the prior art.

In one aspect, the invention provides a structural liner for reinforcing a network of underground water conduits, the structural liner comprising a seamless woven tubular sheath impregnated with a hardening resin; the seamless woven tubular sheath comprising longitudinal fiber warp yam providing tensile strength along a longitudinal axis of the woven tubular sheath and spiralling circumferential fiber filling yam oriented substantially perpendicular to the longitudinal warp yarn providing tensile strength and stiffness around the circumference of the woven tubular sheath.

In an additional aspect, the invention provides a method of reinforcing a network of underground water conduits comprising the steps of inserting a structural liner comprising a seamless woven tubular sheath impregnated with a hardening resin into a portion of the network of underground water conduits such that the structural liner is located inside couplings connecting adjacent pipe segments of the network of underground water conduits; and shaping the structural liner in a tubular form in order to rest structural liner against the inner walls of the pipe segments and couplings of the network of underground water conduits;

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a schematic top plan view of a typical older network of underground water conduits;

FIG. 2 is a schematic view of a structural liner in accordance with one embodiment of the invention;

FIG. 3 is a schematic view of the structural liner of FIG. 2 positioned inside two adjacent pipe segments connected together;

FIG. 4 is a schematic view of the structural liner of FIG. 2 positioned inside an elbow connecting two pipe segments;

FIG. 5 is a schematic view of the structural liner of FIG. 2 positioned inside a tee connection connected to three pipe segments;

FIG. 6 is a schematic view of the structural liner of FIG. 2 positioned inside a bend of an older network of underground water conduits;

FIG. 7 is a schematic cross-sectional view of a pipe segment reinforced with a structural liner subjected to a bending moment;

FIG. 8 is a schematic cross-sectional view of a pipe segment reinforced with a structural liner subjected to a shear force;

FIG. 9 is a schematic cross-sectional view of a pipe segment reinforced with a structural liner subjected to an axial pullout force;

FIG. 10 is a schematic side elevational view of a portion of a network of underground water conduits;

FIG. 11 is a schematic top plan view of the network of underground water conduits illustrated in FIG. 10; and

FIG. 12 is a schematic top plan view of the network of underground water conduits illustrated in FIGS. 10 and 11 with the structural liner partially installed therein.

### DETAILED DESCRIPTION OF THE PREFERRED EMBODIMENTS

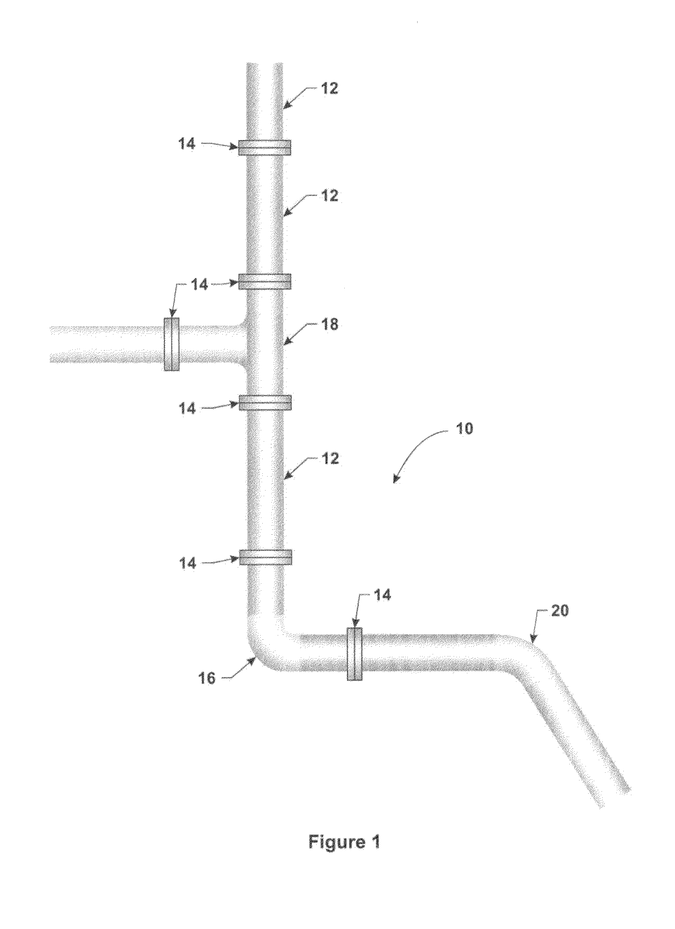

FIG. 1 is a schematic illustration of a portion of a typical older network of underground water conduits 10 comprising a series of straight segments of pipes 12 joined together with couplings 14, elbows 16, tee connections 18 and bends 20. Typical underground conduits for potable water have diameters ranging from 4 inches to 24 inches and the more common diameters range from 6 inches to 12 inches. Underground conduits for potable water have multiple small diameters service entrances ranging from ½ inch to 2 inches typically in diameter connected to residences or businesses supplying the end users with potable water.

In the event of an earthquake or a landslide, the ground motion will exert extreme forces on the water pipe network and the direction of the ground flow will generate axial pullout forces and bending moments around the coupling 14, elbow 16, tee connection 18 and bend 20 due to their specific orientations relative to the direction of the ground flow thereby generating high shear and tensile stresses and strains that, at some connections, will exceed the elastic limits of the pipe connections leading to ruptures in the network of water pipes at various points.

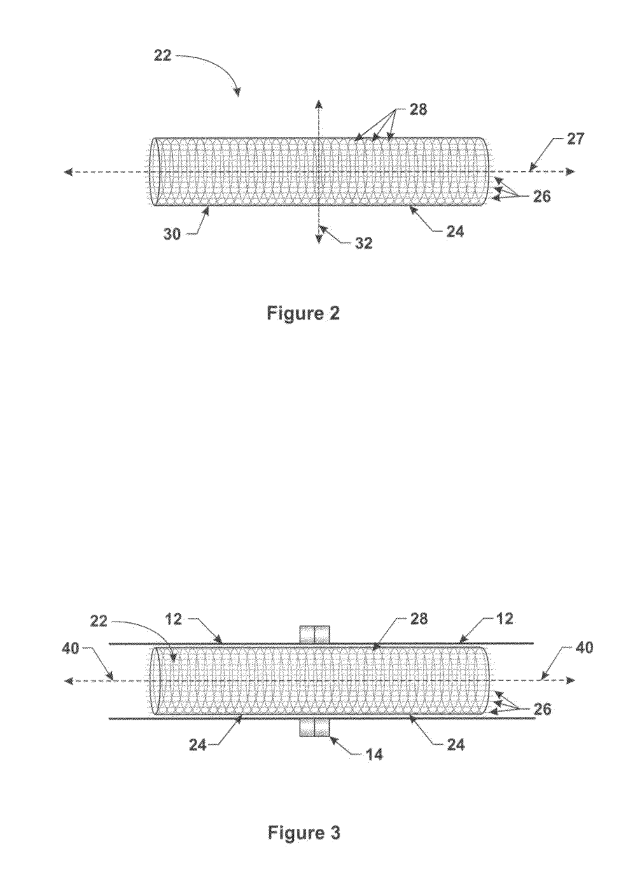

As shown in FIG. 2, in order to reinforce the network of underground conduits 10 particularly at the couplings 14, a structural liner 22 consisting of a seamless woven tubular sheath 24 impregnated with a hardening resin was devised which is adapted for insertion into the network of underground water conduits 10 without the need to excavate because the structural liner 22 remains flexible until its impregnated resin is hardened after it has been installed inside the network of underground conduits 10. The seamless woven tubular sheath 24 consists of continuous longitudinal fiber warp yarns 26 providing tensile strength along the longitudinal axis 27 of the woven tubular sheath 24 and spiralling circumferential fiber filling yarn 28 oriented nearly 90° relative to longitudinal warp yarn 26 providing tensile strength around the wall 30 of the woven tubular sheath 24 along the perpendicular axis 32.

The hardening resin may be curable resin such as an epoxy resin, an unsaturated polyester resin, a vinyl ester resin, or a urethane based resin, or a thermoplastic resin such as a polyolefin, a polyethylene, a polyethylene terephthalate (PET) or technical resin such as NYLON, etc.

The fiber yarn may be made of polyester fibers, fiber glass, carbon fibers, aramid fibers, natural fibers such as cellulosic fibers, like flax or hemp fibers, oriented polyethylene fibers, polyamide fibers or polypropylene fibers.

Once in place inside the network of underground conduits 10 and more specifically inside the couplings 14 connecting two adjacent pipe segments 12, the longitudinal warp yarn 26 of the woven tubular sheath 24 provides added tensile strength to the couplings 14 along the longitudinal axis 40 of the two adjacent pipe segments 12 as shown in FIG. 3. This added tensile strength along the longitudinal axis 40 at the coupling 14 of the two adjacent pipe segments 12 dramatically increases the deformation limit or damage tolerance of the coupling 14 and of the pipe segments 12 thereby enabling the coupling 14 to resist the axial pullout forces, the shear forces and the bending moments generated during an earthquake or a landslide.

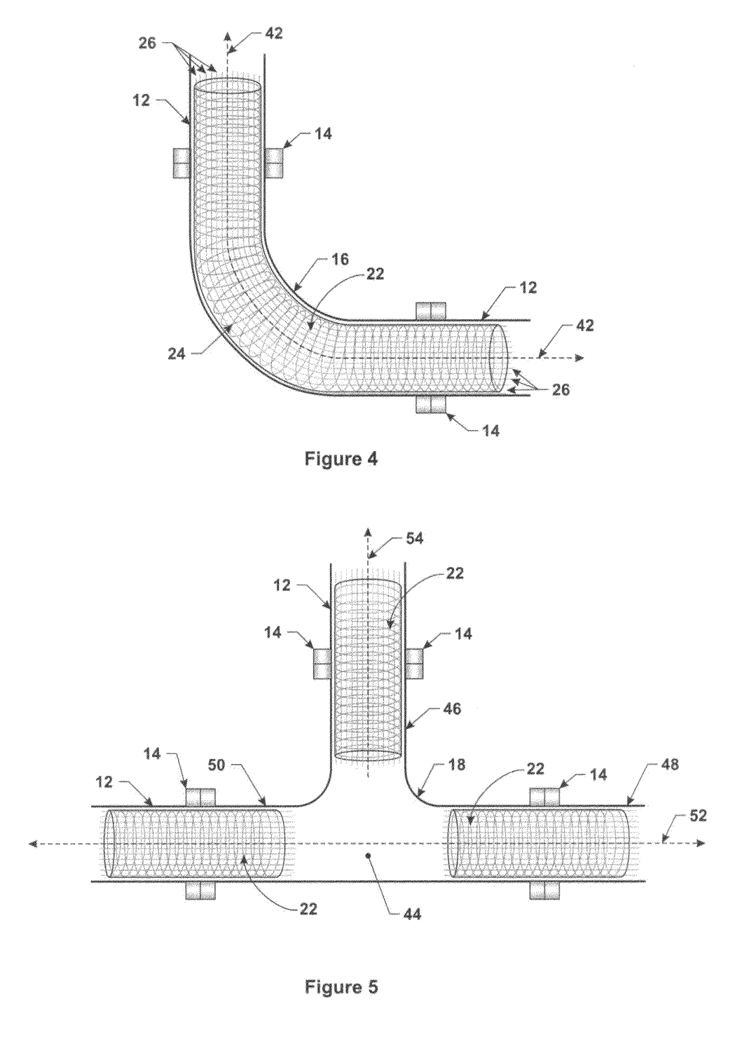

FIG. 4 illustrates a structural liner 22 positioned inside an elbow 16. The woven tubular sheath 24 being flexible prior to curing the resin impregnated therein is adapted to conform to the curvature of the elbow. Once cured in place, the longitudinal warp yam 26 of the woven tubular sheath 24 provides added tensile strength to the couplings 14 connecting the elbow 16 to the pipe segments 12 along the axial direction 42 and provides added tensile strength to the body of the elbow 16. When the elbow 16 and its couplings 14 are subjected to axial pullout forces, shear forces and bending moments during an earthquake or a landslide, the longitudinal warp yarn 26 of the woven tubular sheath 24 increases the resistance of the assembly at the points of maximum strain which enables the assembly of elbow 16 and pipe segments 12 to remain together even if the elbow is subject to deformation.

FIG. 5 illustrates a tee connections 18 connected to three pipe segments 12. Due to the particular configuration of a tee connection, the structural liner 22 cannot reinforce the central portion 44 of the tee connection 18 without blocking one of the branches 46, 48 or 50. However, it is possible to reinforce the couplings 14 connecting the branches 46, 48 and 50 to the pipe segments 12 by inserting structural liners 22 from the pipe segments 12 and ending each structural liner 22 at the junctions of the branches 46, 48 or 50 to the central portion 44 of the tee connection 18 as illustrated. In this manner, the longitudinal warp yam 26 of the woven tubular sheath 24 of the structural liners 22 provides added tensile strength at least to the couplings 14 connecting the tee connection 18 to the pipe segments 12 along the axial directions 52 and 54 where the axial pullout forces, shear forces and bending moments are highest during an earthquake or a landslide.

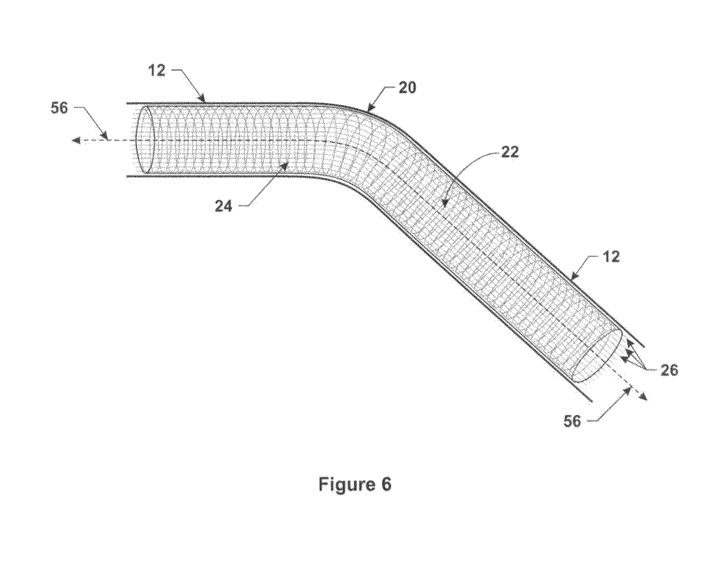

FIG. 6 illustrates a structural liner 22 positioned inside a bend 20. As previously described relative to structural liner 22 positioned inside an elbow 16, the woven tubular sheath 24 being flexible prior to curing the resin impregnated therein is adapted to conform to the curvature of the bend 20. Once cured in place, the longitudinal warp yarn 26 of the woven tubular sheath 24 provides added tensile strength to the bend 20 and to the pipe segments 12 extending from the bend along the axial direction 56. When the bend 20 is subjected to axial pullout forces, shear forces and bending moments during an earthquake or a landslide, the longitudinal warp yarn 26 of the woven tubular sheath 24 increases the resistance of the bend 20 at the points of maximum strain enabling the bend 20 to resist the high tensile strains and stresses generated even if it is subjected to partial deformation.

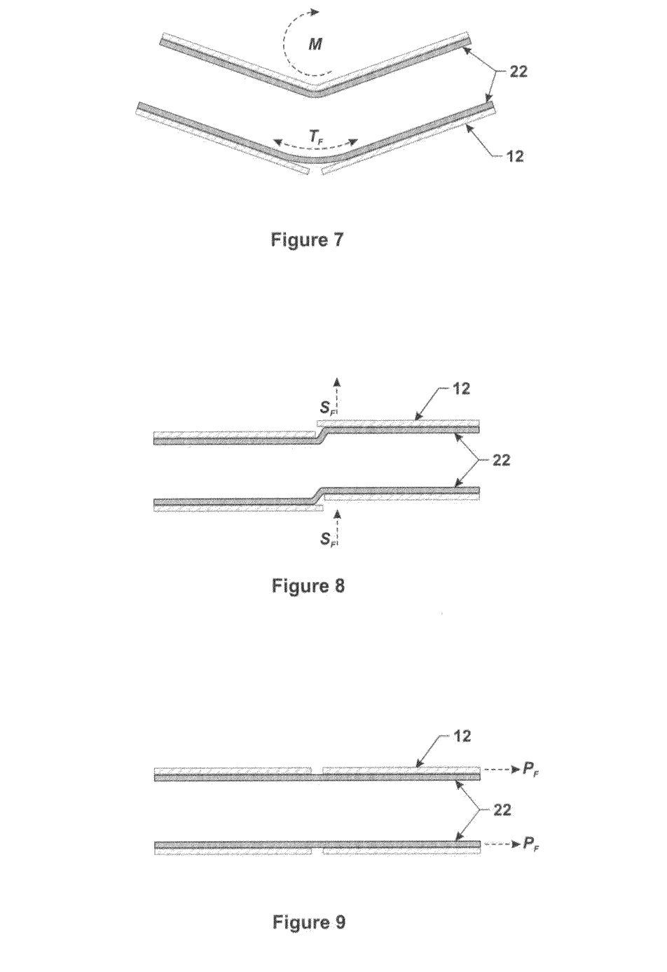

With reference to FIG. 7, which illustrates a pipe segment 12 subjected to a bending moment M, the pipe segment 12 has bent and has fractured and separated at the bend 75 under the localised tension force T_{f}. However, the structural liner 22 inside the pipe segment 12 has remained intact under the bending moment M due to its flexibility and its ability to sustain deformation, The structural liner 22 has stretched at the fracture point and maintained the integrity of the fractured pipe segment 12. The result is that in the aftermath of an earthquake or a landslide, the underground water conduit remains operational.

With reference to FIG. 8, which illustrates a pipe segment 12 subjected to a shear force S_{f} perpendicular to the longitudinal axis of the pipe segment 12, the pipe segment 12 has fractured and separated under the shear force S_{f}. However, as can be seen, the structural liner 22 inside the pipe segment 12 has remained intact under shear force S_{f} due to its flexibility and its ability to sustain deformation. The structural liner 22 has bent at the fracture point and conformed to the displacement of the fractured pipe segment 12. The result is that in the aftermath of an earthquake or a landslide, the underground water conduit remains operational.

With reference to FIG. 9, which illustrates a pipe segment 12 subjected to subjected to an axial pullout force P_{f} along its longitudinal axis, the pipe segment 12 has fractured and separated under the pullout force P_{f}. However, as can be seen, the structural liner 22 inside the pipe segment 12 has remained intact under pullout force P_{f} due to its flexibility and its ability to sustain deformation. The structural liner 22 has stretched at the fracture point and maintained the integrity of the fractured pipe segment 12. The result is that in the aftermath of an earthquake or a landslide, the underground water conduit remains operational.

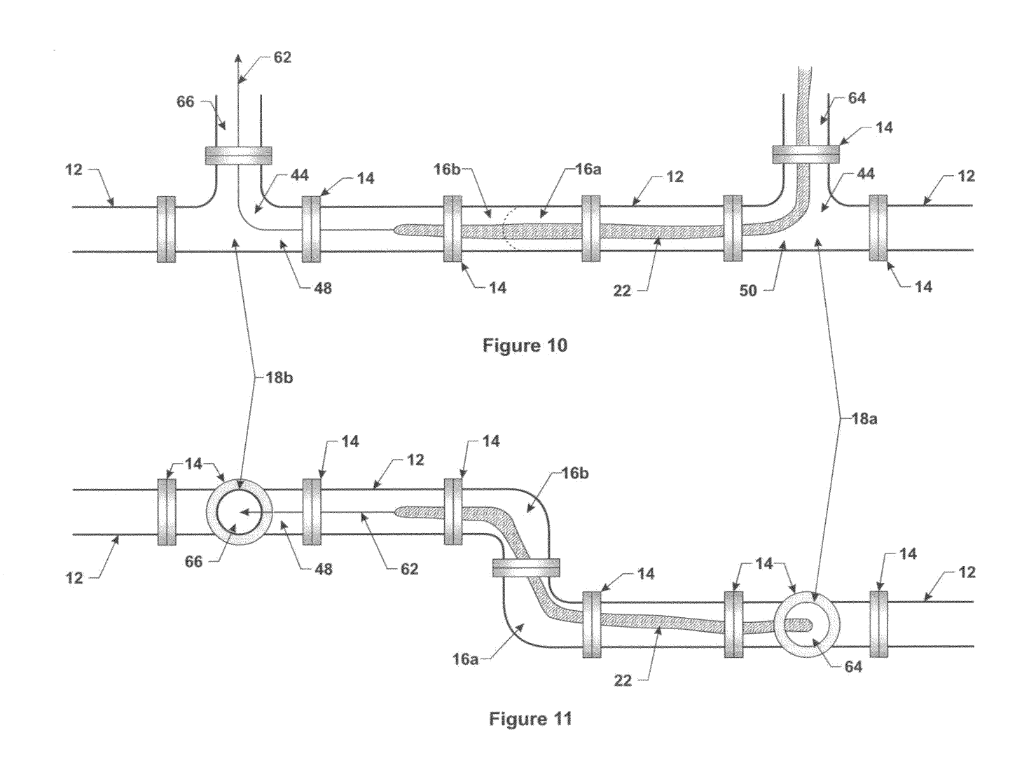

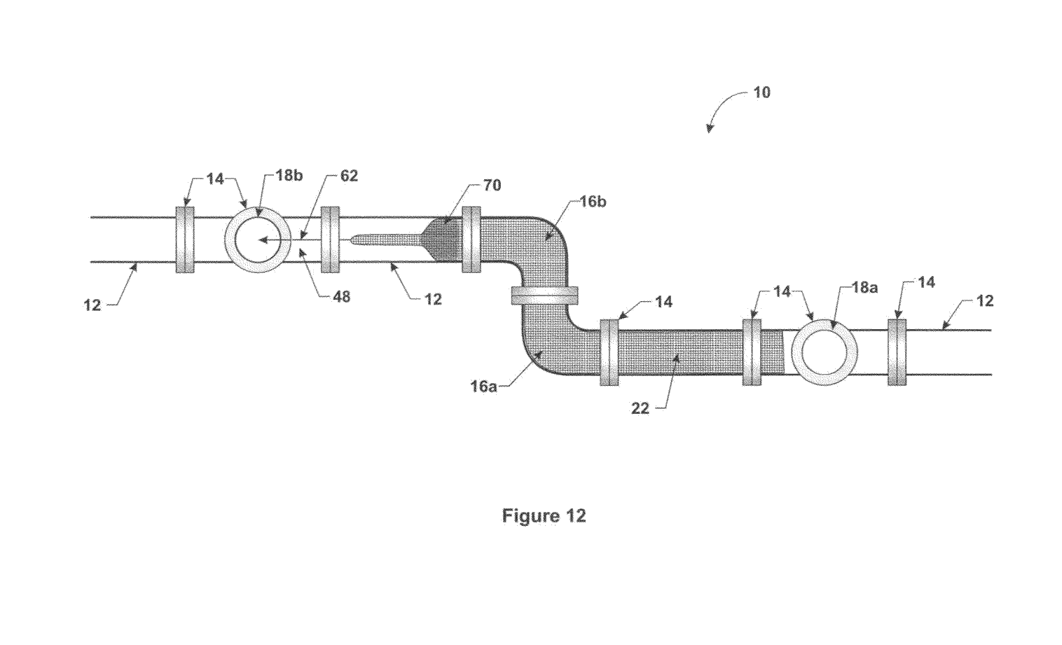

With reference to FIG. 10, which illustrates a side view of a portion of a typical older network of underground water conduits 10 comprising a series of straight segments of pipes 12 joined together with couplings 14, elbows 16, tee connections 18 and FIG. 11 which is a plan view of the same portion of the network of underground water conduits 10 illustrated in FIG. 10, a winch cable 62 is initially inserted into the network of underground water conduits 10 entering through first pipe segment 64 connected above ground to a fire hydrant for example and exiting through a second pipe segment 66 connected above ground to another fire hydrant for example. The structural liner 22 comprising the woven tubular sheath 24 impregnated with resin is then attached to the winch cable 62 and pulled into the network 10 by a winching device (not shown) attached to the cable 62. The flexibility of the structural device 22 allows it to be pulled through the first tee connection 18a and through the first and second elbows 16a and 16b as illustrated. The structural liner 22 is pulled through the whole length of the portion of the network of underground water conduits 10 in this manner.

As previously mentioned with reference to a tee connection 18, the structural liner 22 cannot be pulled into the central portion 44 of the tee connection 18b without blocking one of its branches. The front end of the structural liner 22 is therefore pulled up to the junction of the branch 48 and the central portion 44 of the tee connection 18b and released. Similarly, the length of the structural liner 22 is calculated such that its rear end is located at the junction of the branch 50 and the central portion 44 of the tee connection 18a.

FIGS. 10 and 11 illustrate and describe a pull-in-place process of installing the structural liner 22 into network of underground water conduits 10. However, an inversion process may also be used in which the resin impregnated structural liner 22 is inverted and pushed inside the water conduits 10 by applying hydrostatic or air pressure against the internal walls of the structural liner 22 such that the structural liner 22 reverses and deploys right side up against the walls of the water conduits 10.

After the insertion of the structural liner 22 into the portion of the network of underground water conduits 10, the woven tubular sheath 24 impregnated with resin is resting flat on the bottom of the water conduits 10 and must be shaped to take its final tubular form in order to rest against the inner walls of the pipe segments 12 and couplings 14, elbows 16 and the couplings of the branches 48 and 50 of the tee connections 18a and 18b. The shaping of the structural liner 22 against the inner walls of the network of underground water conduits 10 is accomplished by passing a shaping member or pig 70 preferably pushed along the structural liner 22 by pressurized water. The pig 70 pushes the woven tubular sheath 24 outwardly against the inner walls of the pipe segments 12 and couplings 14, elbows 16 and the couplings of the branches 48 and 50 of the tee connections 18a and 18b and assumes its final tubular shape.

After the shaping of the structural liner 22 against the inner walls of the network of underground water conduits 10, the curable resin is cured in place. The curing of the resin is preferably achieved by the effect of the passage of hot pressurised water through the structural liner 22. The transfer of the heat from the water to the curable resin allows the cross-linking reaction to take place, and thus the curing of the resin. The curing of the resin maintains the woven tubular sheath 24 in its tubular shape and provides mechanical integrity and rigidity to the structural liner 22. Furthermore, the curing of the resin may advantageously bond the woven tubular sheath 24 to the inner walls of the network of underground water conduits 10.

If a structural liner 22 pre-impregnated with a thermoplastic resin or comprising a thermoplastic resin in the form of comingled fibres is used, the thermoplastic is consolidated through heating and pressurizing for a given period of time by means of pressurized hot water, steam or hot air or other means to bring the thermoplastic to its consolidation point i.e. slightly above its melting temperature, in order for it to melt, wet-out the fibres of the structural liner, and solidify upon cooling, resulting in a structural thermoplastic composite liner.

Once installed and cured, the structural liner 22 reinforces the entire network of underground water conduits 10 and more specifically around the couplings 14, elbows 16, tee connections 18 and bends 20 which are more susceptible to breakage under the axial pullout forces, shear forces and bending moments generated earthquakes and landslides.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A structural liner for reinforcing a network of underground water conduits, the structural liner comprising a seamless woven tubular sheath impregnated with a hardening resin; the seamless woven tubular sheath comprising longitudinal fiber warp yarn providing tensile strength along a longitudinal axis of the woven tubular sheath and spiralling circumferential fiber filling yarn oriented substantially perpendicular to the longitudinal warp yarn providing tensile strength and stiffness around the circumference of the woven tubular sheath.

2. A structural liner as defined in claim 1, wherein the fiber of the longitudinal fiber warp yarn and of the spiralling circumferential fiber filling yarn is selected from the group consisting of polyester fibers, fiber glass, carbon fibers, aramid fibers, natural fibers, oriented polyethylene fibers, polyamide fibers and polypropylene fibers.

3. A structural liner as defined in claim 1, wherein the hardening resin is selected from the group of curable resin such as epoxy resin, unsaturated polyester resin, vinyl ester resin, and urethane based resin or a thermoplastic resin such as a polyolefin, a polyethylene, a polyethylene terephthalate (PET) or technical resin.

4. A structural liner as defined in claim 1, wherein the structural liner is specifically adapted to reinforce couplings connecting adjacent pipe segments of the network of underground water conduits.

5. A method of reinforcing a network of underground water conduits comprising the steps of:
inserting a structural liner as defined in claim 1 into a portion of the network of underground water conduits such that the structural liner is located inside couplings connecting adjacent pipe segments of the network of underground water conduits;
shaping the structural liner in a tubular form in order to rest the structural liner against the inner walls of the pipe segments and couplings of the network of underground water conduits;
hardening the resin with the use of heat in order to maintain the structural liner in its tubular shape.

6. A method as defined in claim 5 wherein the structural liner is inserted into the portion of the network of underground water conduits by a pull-in-place process.

7. A method as defined in claim 5 wherein the structural liner is inserted into the portion of the network of underground water conduits by an inversion process.
